(19) United States
(12) Patent Application Publication
(10) Pub. No.: US 2015/0090195 A1
(43) Pub. Date: Apr. 2, 2015

(54) PET TEMPERAMENT SYSTEM AND METHOD

(71) Applicant: Leila Krupich, Calgary (CA)

(72) Inventor: Leila Krupich, Calgary (CA)

(21) Appl. No.: 14/039,118

(22) Filed: Sep. 27, 2013

(51) Int. Cl. A01K 27/00

(52) U.S. Cl. CPC A01K 27/002; A01K 27/003
USPC 119/792; 119/858; 119/795; 40/303

(57) ABSTRACT

An example pet temperament indication may be provided on a harness or a leash. A symbol representative of one of a variety of pre-established pet temperaments may be provided to the harness and/or leash to allow for appreciating the temperament of a pet wearing the harness from a distance. The indication may include a first symbol if a pet's temperament is friendly, a second symbol if the pet's temperament is sometimes unfriendly, a third symbol if the pet's temperament is unfriendly and providing a fourth symbol if the pet's temperament is unclear or special. Any combination of symbols may also be used.

### BACKGROUND

Pet owners and handlers frequently enjoy taking their pets with them wherever they go. As with humans, a variety of biological and environmental factors contribute to the temperament of individual pets. As such, pets express a variety of natural temperaments. While owners, handlers and guardians of a particular pet may be aware of the pet's natural temperament, this temperament is often unclear to those outside of the pet's typical circle of association. This lack of clarity may be dangerous if the pet is unfriendly. For example, if any unfriendly pet is approached, the pet may react aggressively to other pets or humans. In other cases, a friendly pet that enjoys contact may miss this interaction if the pet's friendly temperament is unknown to those who may encounter the pet.

### BRIEF DESCRIPTION OF THE DRAWINGS

FIG. 1 is a perspective view of a pet wearing an example pet temperament harness.

FIG. 2 is a left side view of the pet wearing the example pet temperament harness.

FIG. 3 is a right side view of the pet wearing the example pet temperament harness.

FIG. 4 is a rear view of the example pet temperament harness.

FIG. 5 is a front view of the example pet temperament harness.

FIG. 6 is a top view of the example pet temperament harness.

FIG. 7 is a bottom view of the example pet temperament harness.

FIG. 8 is a perspective view of a pet wearing an example pet temperament harness.

FIG. 9 is a perspective view of a pet wearing an example pet temperament harness.

FIG. 10 is a perspective view of a pet wearing an example pet temperament harness.

FIG. 11 is a perspective view of a pet wearing an example pet temperament harness.

FIG. 12 is a side view of an example leash for use with example pet temperament harnesses.

FIG. 13 is a top view of the example leash.

FIG. 14 is a bottom view of the example leash.

FIG. 15A is a right side view of an upper portion of the example pet temperament harness illustrating example fasteners.

FIG. 15B is a left side view of an upper portion of the example pet temperament harness illustrating example fasteners.

FIG. 15C is a perspective view of the example leash.

### DETAILED DESCRIPTION

An example system and method for indicating pet temperament is disclosed herein as the system and method may inform others not acquainted with a pet about the pet's temperament so that the others may act appropriately towards the pet. The system and method enables a pet to wear an indication clarifying for others whether the pet is generally receptive to approach or generally not receptive to approach. In an example, the system includes visual indicators which are readily understood, visible at distance and in the daytime or at night.

Before continuing, it is noted that as used herein, the terms “includes” and “including” mean, but is not limited to, “includes” or “including” and “includes at least” or “including at least.” The term “based on” means “based on” and “based at least in part on.”

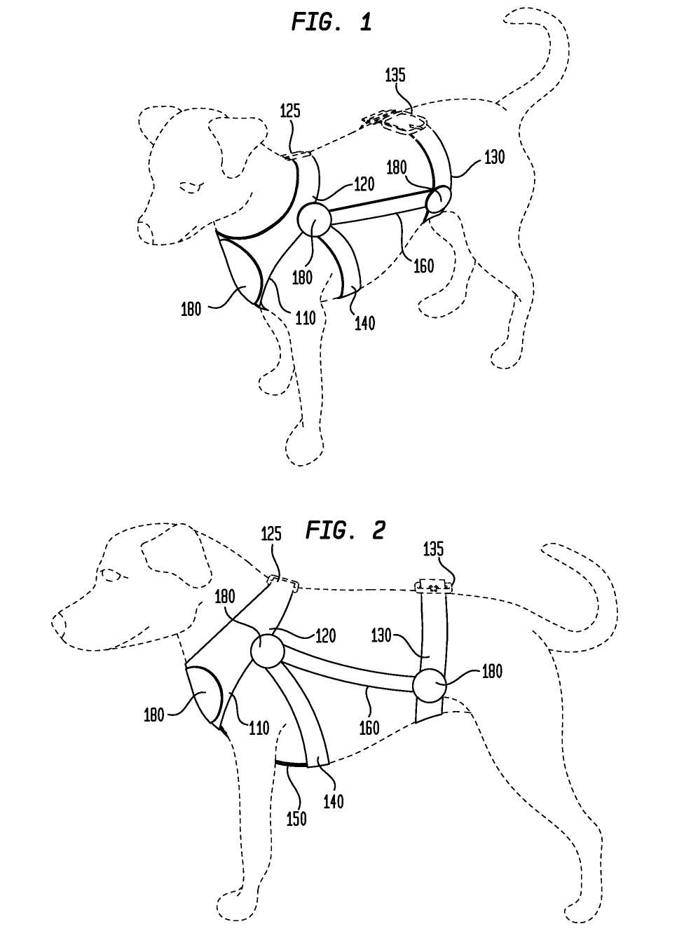

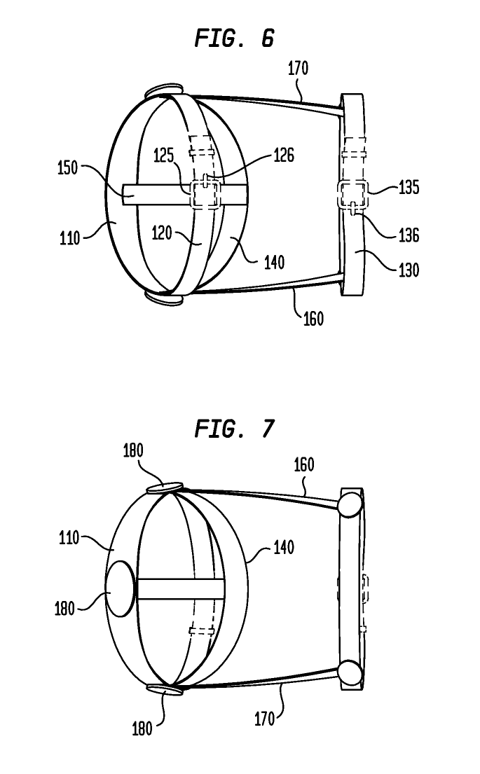

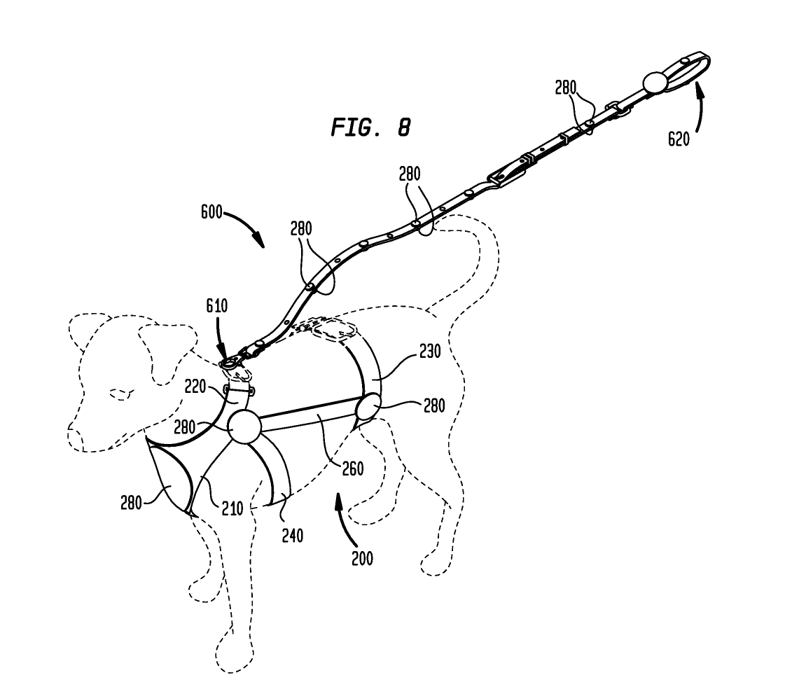

An example pet temperament indication may be provided on a harness, vest, or other item that can be attached or worn by the pet. For example, the pet temperament indication may be provided with means for engaging the neck and/or chest and/or other body part of a pet. In the example illustrated in FIGS. 1-7, a neck loop is formed by a chest bib 110 coupled with a neck strap 120. However, any of a variety of means may be used, e.g., to form a loop to engage the neck of a pet.

Means may also be provided for adjusting a length of the neck loop such that the size of the neck loop can be varied, as needed, to fit a variety of neck sizes of the pet. In the example illustrated in FIGS. 1-7, a buckle is provided to an end of right portion of neck strap 120. Buckle 125 includes a loop for receiving the left portion of neck strap 120 and a prong 126 for engaging holes 129 provided in left portion (FIG. 6). A sternum strap 150 (FIGS. 2-7) may be coupled to a lower portion of chest bib 110 and extends away therefrom.

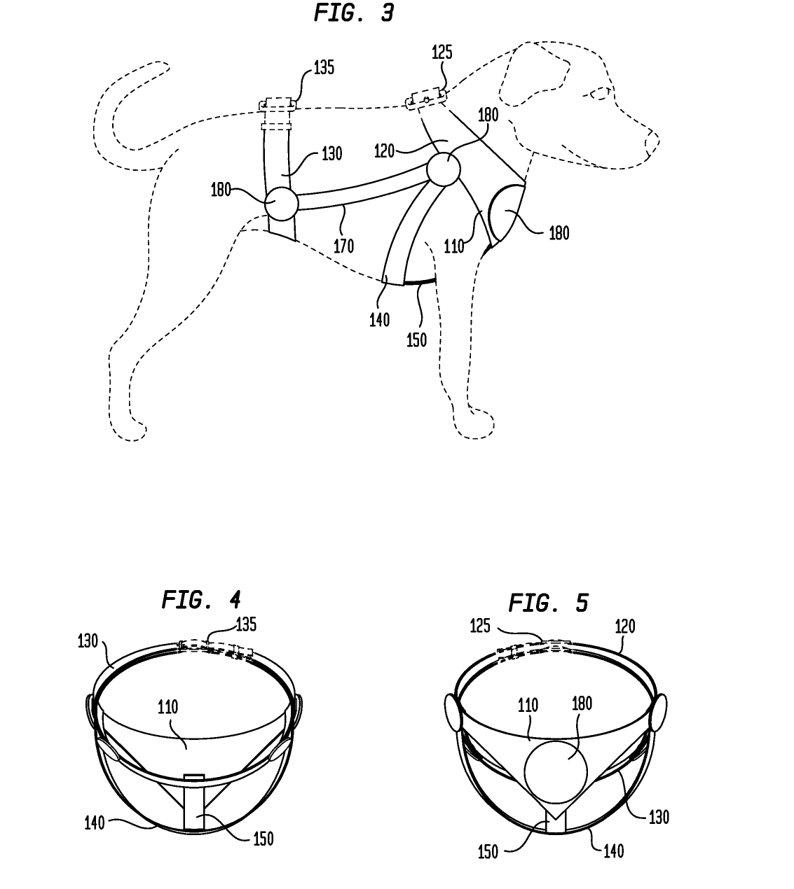

Means may be provided for coupling the neck loop with another loop which may be provided with the harness. As illustrated by way of example in FIGS. 1-7, rib straps 160 (FIGS. 1, 2 & 6-8) and 170 (FIGS. 3, 6 & 7) extend from forward ends coupled with the neck loop to rearward ends away from the neck loop.

The harness may also include means for engaging the waist of a pet. In the example illustrated in FIGS. 1-7, a waist loop is defined by a waist strap 130 coupled with the rearward ends of rib straps 160 and 170. Waist strap 130 further includes means for adjusting the length thereof such that the size of the waist loop can be varied, as needed, to fit a variety of waist sizes. In the example illustrated in FIGS. 1-7, a buckle 135 is provided to one end of waist strap 130. Buckle 135 includes a loop for receiving the opposite end of waist strap 130 and a prong 136 for engaging holes 139 provided in strap 130.

Leg strap 140 may include a middle portion coupled with sternum strap 150 and ends coupled with the neck loop. The loop formed by chest bib 110 and leg strap 140 is divided into two leg loops by sternum strap 150.

Means for indicating a temperament of any pet wearing a harness may be provided at a variety of locations on the harness. In the example illustrated in FIGS. 1-7, at least one symbol 180 is representative of one of a variety of pre-established pet temperaments. Pre-established pet temperaments may include but are not limited to friendly, sometimes unfriendly, unfriendly and unknown/special. To represent a pet temperament, symbols of a variety of shapes, colors or both are coded to a corresponding number of temperaments. For example, four temperaments may be represented by four different colorations, four different shapes or four different shapes all having different colorations. In some examples, each symbol may be coded in a plurality of colors or each may be coded in a single color.

In an example, the colors green, yellow, red and blue are coded to correspond with an indication such as “go ahead and approach” or a “friendly” pet; “approach with caution” or a “sometimes unfriendly” pet; a “do not approach” or an “unfriendly” pet; and “ask before approaching” for an “uncertain” or “special” pet; respectively. However, any of a variety of readily distinguishable colors and/or other indicators may be used to code different pet temperaments.

In an example, the shapes circular, triangular, polygonal and square are coded to correspond with an indication such as “go ahead and approach” or a “friendly” pet; “approach with caution” or a “sometimes unfriendly” pet; “do not approach” or an “unfriendly” pet; and “ask before approaching” for an “uncertain” or “special” pet; respectively. However, any of a variety of readily distinguishable shapes may be used to code different pet temperaments.

In yet another example, a “go ahead and approach” message or a “friendly” pet is designated with a green circular symbol; an “approach with caution” message or a “sometimes unfriendly” pet is designated with a yellow triangular symbol; a “do not approach” message or an “unfriendly” pet is designated with a red polygonal symbol; and an “ask before approaching” message or an “uncertain” or “special” pet is designated with a blue square symbol. However, any of a variety of readily distinguishable combinations of colors and shapes and/or other indications may be used to code different pet temperaments.

Harness straps including 120, 130, 140, 150, 160 and 170 may be formed of any of a variety of soft, flexible, lightweight, durable materials including but not limited to leather, hemp and synthetic polymers such as nylon. In some examples, one or more padding materials may be provided to portions of the straps which contact the pet when worn.

Chest bib 110 may be formed of the same material or materials used to construct straps 120, 130, 140, 150, 160 and 170 or a different material. In some examples, chest bib 110 may be formed of a more rigid material than straps 120, 130, 140, 150, 160 and 170.

Harness 100 may include or be constructed partly or entirely of a reflective material to improve visibility thereof. As such, harness 100 and therefore, any pet wearing harness 100, may be easier to see in low lighting. For example, symbols 180 or chest bib 110 may include reflective properties. In an example, illuminating devices such as but not limited to light emitting diodes (LEDs) may be provided on harness 100 for additional visibility.

It should be noted that any of a variety of adjustment means other than buckles 125 and 135 may be provided to harness 100. For example, hook-and-loop fasteners such as Velcro™ may be provided to left and right portions of neck strap 120 or near opposite ends of waist strap 130.

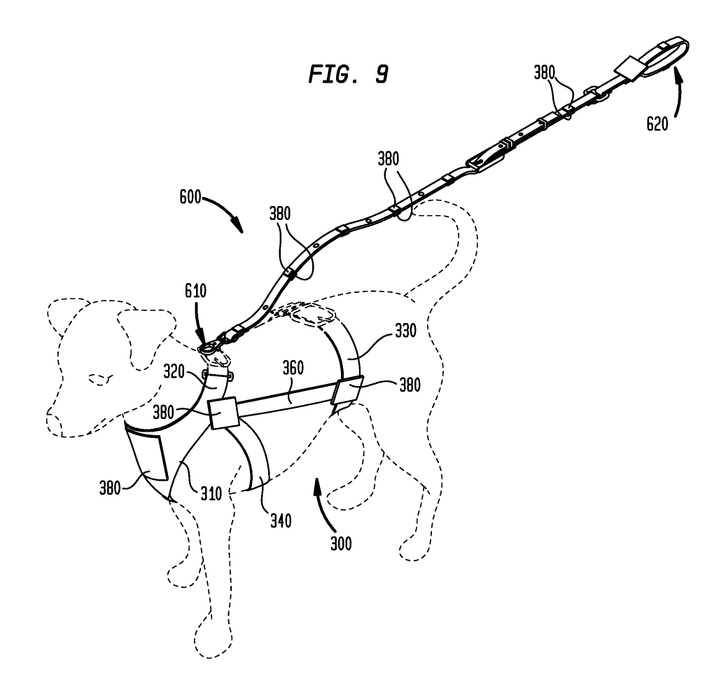

FIG. 8 is a perspective view of a pet wearing an example “friendly” pet temperament harness to which an example pet temperament leash is coupled. In FIG. 8, the symbols are shown removed to reveal a hook-and-loop type fastener 280, to which any of a variety of different symbols 180 may be attached. For example, in FIGS. 1-7, the symbol 180 is shown having a circular shape and may also be a green color representative of a friendly pet temperament sending a message “approach.” Referring to FIG. 8, the symbol may be provided on the hook-and-loop type fastener 280 on chest bib 210, exterior surface of neck strap 220 near junctions with leg strap 220 and to an exterior surface of waist strap 230 near junctions with rib straps 260 and 270 and/or on the leash 600. However in some examples, harness 200 and leash 600 do not include symbols at all of these locations whereas in other examples, symbols may be provided in additional locations. Other types of symbols will now be illustrated with reference to FIGS. 9-11 as these symbols may be connected to the harness and/or leash.

FIG. 9 is a perspective view of a pet wearing an example “special” pet temperament harness to which an example pet temperament leash is coupled. Symbol 380, having a square shape and a blue color, is representative of an uncertain/special pet temperament sending the message “ask before approaching.” Referring to FIG. 9, symbol 380 is provided on chest bib 310, exterior surface of neck strap 320 near junctions with leg strap 340 and to an exterior surface of waist strap 330 near junctions with rib straps 360 and 370. However in some examples, harness 300 does not include symbols at all of these locations whereas in other examples, symbols may be provided in additional locations.

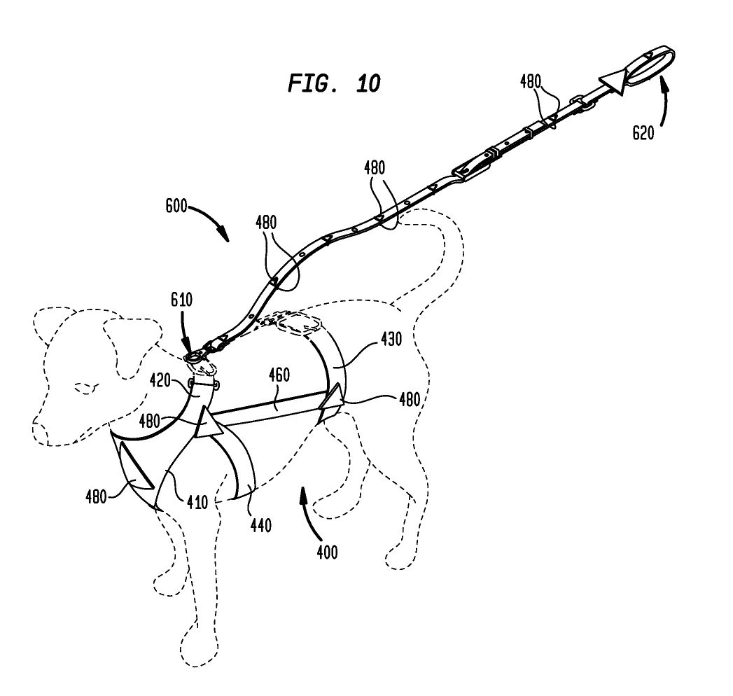

FIG. 10 is a perspective view of a pet wearing an example “sometimes unfriendly” pet temperament harness to which an example pet temperament leash is coupled. Symbol 480, having a triangular shape and a yellow color, is representative of a sometimes unfriendly pet temperament sending the message “yield” or “approach with caution.” Referring to FIG. 10, symbol 480 is provided on chest bib 410, exterior surface of neck strap 420 near junctions with leg strap 420 and to an exterior surface of waist strap 430 near junctions with rib straps 460 and 470. However in some examples, harness 400 may not include symbols at all of these locations whereas in other examples, symbols may be provided in additional locations.

FIG. 11 is a perspective view of a pet wearing an example “unfriendly” pet temperament harness to which an example pet temperament leash has been coupled. Symbol 580, having an polygonal (e.g., hexagonal is shown, but may be octagonal or other polygon) shape and a red color, is representative of an unfriendly pet temperament sending the message “stop” or “do not approach.” Referring to FIG. 11, symbol 580 is provided on chest bib 510, exterior surface of neck strap 520 near junctions with leg strap 540 and to an exterior surface of waist strap 530 near junctions with rib straps 560 and 570. However in some examples, harness 500 does not include symbols at all of these locations whereas in other examples, symbols may be provided in additional locations.

While four temperaments have been described for purposes of illustration by four symbols each having one of four colors and one of four shapes, it is noted that any number and/or types of temperaments may be represented. In an example, a different number of colors or shapes and/or a different number of combinations of colors and shapes and/or other indicators (e.g., strips, bars, etc.) may be used to indicate temperament.

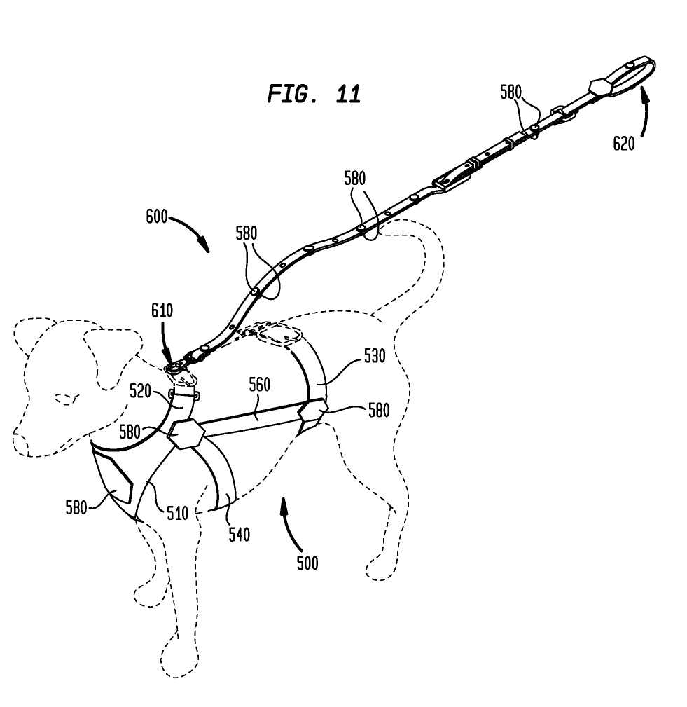

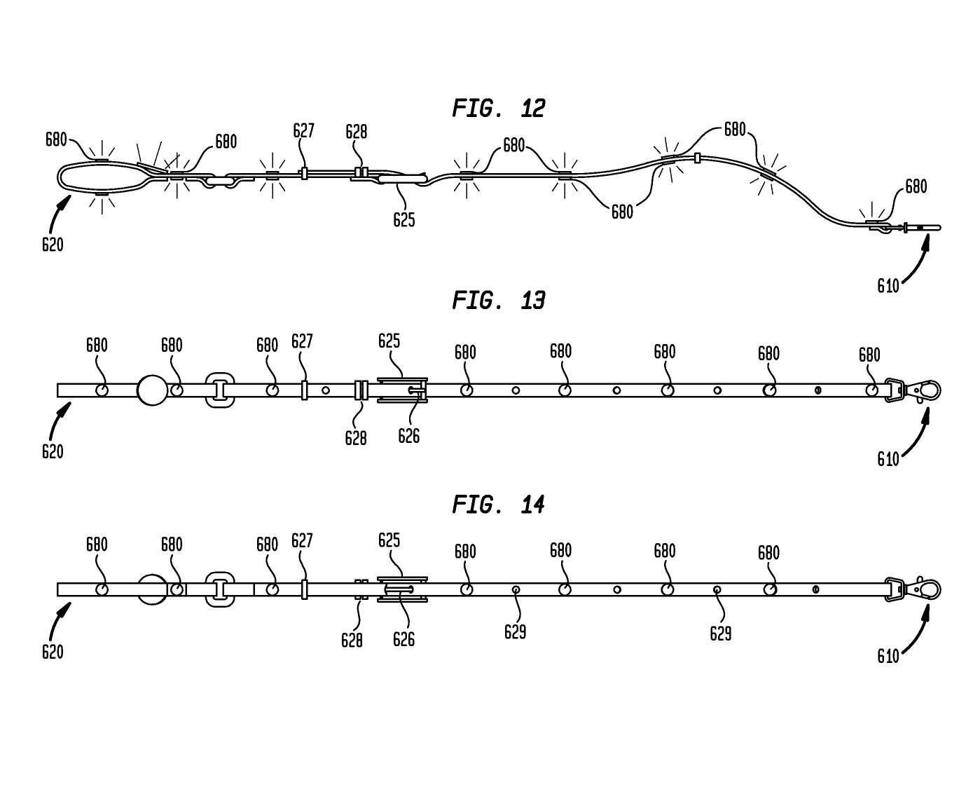

FIG. 12-14 are side, top and bottom views, respectively, of an example leash that may be provided with a pet temperament harness. Leash 600 includes a handle 620 (handle loop) at a first, proximal end and a clasp or other connector 610 at a second, distal end. Leash 600 is provided with a symbol 680 at a plurality of locations between the first and second ends. As with symbols 180, 280, 380 and 480, symbol 680 is representative of one of a variety of pre-established pet temperaments. In some examples, symbol 680 is provided so as to match with symbols provided to the harness with which the leash is being used.

The length of the leash 600 is adjustable to enable shortening and lengthening thereof. A buckle 625 coupled with a first portion of leash 600 includes a loop for receiving a second portion of leash 600 and a prong 626 for engaging one of a plurality of holes 629 formed in the leash 600. Single loop 627 and double loop 628 are provided for holding, to leash 600, excess leash resulting from shortening of leash 600.

Leash 600 may be formed of the same material or materials used to construct straps 120, 130, 140, 150, 160 and 170 or a different material. Likewise, leash 600 may include or be constructed partly or entirely of a reflective material and/or LED lighting or the like to improve visibility thereof. As such, leash 600 and therefore, any pet tethered to or owner holding leash 600, may be easier to see in low lighting. For example, symbols 680 may include reflective properties.

In some examples, harness 100 may be used with leashes other than leash 600 or without a leash. In some examples, leash 600 may be used without any of harnesses 100, 200, 300, 400 or 500 or with harnesses different from these.

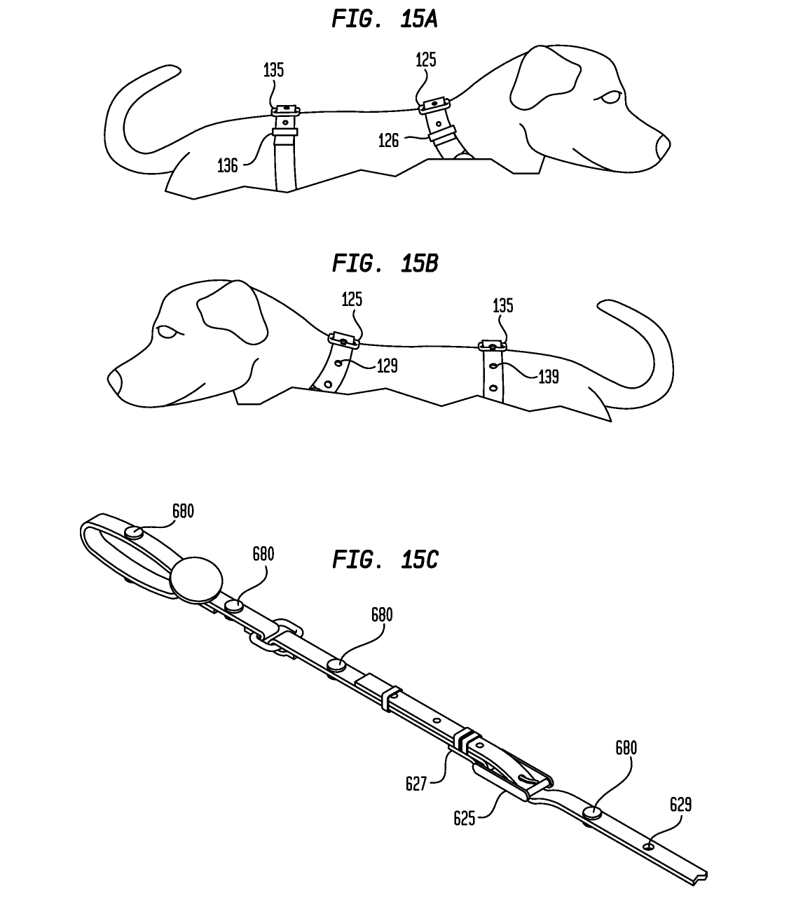

FIG. 15A is a right side view of an upper portion of the example pet temperament harness of FIGS. 1-7 emphasizing example fasteners 125 and 135 as well as retaining loops 126 and 136.

FIG. 15B is a left side view of an upper portion of the example pet temperament harness of FIGS. 1-7 emphasizing example fasteners 125 and 135 as well as prong holes 129 and 139.

FIG. 15C is a perspective view of the example leash of FIGS. 12-14 emphasizing example fastener 625 as well as retaining loops 627 and 628 and prong holes 629.

Before continuing, it should be noted that the examples described above are provided for purposes of illustration, and are not intended to be limiting. Other devices and/or device configurations may be utilized to carry out the operations described herein.

An example of a method of indicating pet temperament is now described with reference to the Figures described above, and in particular with reference to FIG. 2. A harness 100 is provided to include a neck loop formed by strap 120 and bib 110 and a waist loop formed by strap 130. Rib straps 160 and 170 are provided extending between the neck loop and the waist loop.

A first length adjustment apparatus 125 is provided to the neck loop and a second length adjustment apparatus 135 is provided to the waist loop, so that harness may be easily adapted to comfortably fit a given pet.

At least one symbol representative of one of a variety of pre-established pet temperaments is also provided to the harness. If the temperament of the pet who will wear the harness is “friendly,” a symbol of a first color and first shape is provided at one or more locations on harness 100. If the temperament of the pet who will wear the harness is “sometimes unfriendly,” a symbol of a second color and second shape is provided at one or more locations on harness 100. If the temperament of the pet who will wear the harness is “unfriendly,” a symbol of a third color and third shape is provided at one or more locations on harness 100. If the temperament of the pet who will wear the harness is “unclear” or “special,” a symbol of a fourth color and fourth shape is provided at one or more locations on harness 100.

With the harness 100 provided, the harness may be placed on or fitted to a pet as illustrated in FIG. 2. During use, chest bib 110 engages a portion of the pet's chest below the neck and slightly above where the forelegs meet with the torso. Neck strap 120 extends from chest bib 110 above the pet's shoulders and behind the neck near the pet's scapulae.

To begin placement of harness 100 on a pet, the user assists the pet with insertion of the forelegs into the left and right leg holes formed between neck bib 110, leg strap 140 and sternum strap 150. When fitting neck strap 120 and chest bib 110 around the neck of a pet, the left and right portions of neck strap 120 may begin disengaged as the pet steps into the leg loops and are subsequently engaged to form a loop using buckle 125, buckle prong 126 and prong holes 129. To form a smaller neck loop, more of the left portion of strap 120 is inserted through buckle 125. To form a larger neck loop, less of the left portion of strap 120 is inserted through buckle 125. With the neck loop at an appropriate size, buckle prong 126 is inserted into the nearest prong hole 129.

With the front portion of harness 100 fitted to the pet, disengaged waist strap 130 may be placed around the pet's waist and the first and second ends thereof engaged using buckle 135 and buckle prong 136 provided on the strap first end. To form a smaller waist loop, the second end of strap 120 is inserted a further distance through buckle 135. To form a larger waist loop, the second end of strap 130 is inserted a lesser distance through buckle 135. With the waist loop at an appropriate size, buckle prong 136 is inserted into the nearest prong hole 139.

While wearing the harness, persons encountering the pet will be able to recognize symbol 180 and conclude the temperament of the pet so that the person or persons may act accordingly towards the pet.

If a user desires added control over his or her pet, the user may couple leash 600 to harness 100 at neck strap 120 using a clasp or other connector 610. For example, the clasp or connector 610 may be coupled with the loop of buckle 125 or with another loop provided at, on or near neck strap 120.

As mentioned above, for added proclamation of a pet's temperament, a symbol 680 may be provided to the leash in one or more locations. While symbol 680 will generally match with symbol 180 provided to harness 100, in some circumstances a user may desire to provide a leash having a symbol different from that of harness 100.

As with neck strap 120 and waist strap 130, leash 600 is provided with a means for changing its length. To shorten leash 600, the leash end including connector 610 is drawn towards the end including handle loop 620 through buckle 625 until the desired length is achieved. Buckle prong 626 is then inserted into the nearest prong hole 629 to hold the leash at this desired length. To lengthen leash 600, the leash end including connector 610 is drawn away from the end including handle loop 620 through buckle 625 until the desired length is achieved. Buckle prong 626 is then inserted into the nearest prong hole 629 to hold the leash at this desired length. Any excess leash material may be held to leash 600 with loops 627 and 628.

While the operations show and describe use of example harness 100, example harnesses 200, 300, 400 and 500 may be similarly used.

The operations shown and described herein are provided to illustrate example implementations. It is noted that the operations are not limited to the ordering shown. Still other operations may also be implemented. For example, in some circumstances, a user may desire to place waist strap 130 around a pet's waist before fitting the neck loop to the pet. In another example, leash 600 may be coupled with harness 100 before harness 100 is fitted to the pet.

It is noted that the examples shown and described are provided for purposes of illustration and are not intended to be limiting. Still other examples are also contemplated.

1. A pet temperament indication system, comprising:
a harness including a neck loop formed by a chest bib coupled with a neck strap, rib straps extending, from forward ends coupled with the neck loop, to rearward ends away from the neck loop, a waist loop defined by a waist strap coupled with the rib strap rearward ends, a leg strap coupled with the neck loop, and a sternum strap coupled, at a first end, to the neck loop and, at a second end, to the leg strap; and
at least one symbol representative of one of a variety of pre-established pet temperaments.

2. The system of claim 1, wherein the pre-established temperaments include friendly, sometimes unfriendly, unfriendly and unknown.

3. The system of claim 1, wherein the at least one symbol includes one of a variety of colors each having a pre-determined correspondence with one of the pre-established temperaments.

4. The system of claim 1, wherein the at least one symbol includes one of a variety of shapes each having a pre-determined correspondence with one of the pre-established temperament.

5. The system of claim 1, wherein the at least one symbol is provided on the chest bib.

6. The system of claim 1, further comprising a leash including:
a handle at a first, proximal end;
a clasp at a second, distal end; and
at least one symbol representative of one of a variety of pre-established pet temperaments.

7. The system of claim 1, wherein the at least one symbol is interchangeable with other symbols to indicate a variety of temperaments.

8. The system of claim 1, wherein the at least one symbol is distinguished from other symbols, each symbol visually indicating to another person a distinct temperament of a pet wearing the harness.

9. The system of claim 1, further comprising reflective material provided on the harness and leash to improve visibility thereof.

10. The system of claim 1, further comprising lighting provided on the harness and leash to improve visibility thereof.

11. A method of indicating pet temperament, comprising:
providing a harness or leash for a pet; and
providing on the harness or leash at least one visual symbol representative of one of a variety of pre-established pet temperaments.

12. The method of claim 11, wherein providing at least one symbol further comprises:
providing the symbol of a first color if the temperament to be indicated is friendly;
providing the symbol of a second color if the temperament to be indicated is sometimes unfriendly;
providing the symbol of a third color if the temperament to be indicated is unfriendly; and
providing the symbol of a fourth color if the temperament to be indicated is unknown or special needs.

13. The method of claim 11, wherein providing at least one symbol further comprises:
providing the symbol of a first shape if the temperament to be indicated is friendly;
providing the symbol of a second shape if the temperament to be indicated is sometimes unfriendly;
providing the symbol of a third shape if the temperament to be indicated is unfriendly; and
providing the symbol of a fourth shape if the temperament to be indicated is special needs.

14. The method of claim 11, wherein providing at least one symbol further comprises providing a plurality of symbols representative of the same pre-established temperament.

15. The method of claim 11, further comprising providing a combination of color and shape to indicate pet temperament.

16. The method of claim 15, further comprising providing a symbol on the leash that is the same as the at least one symbol on the harness.

17. The method of claim 11, further comprising providing a symbol on the leash that is the different than the at least one symbol on the harness, but together indicating the same pet temperament.

18. A pet temperament indicator, comprising:
means for engaging a pet; and
means for indicating a temperament of any pet wearing the means for engaging the pet.

19. The pet temperament indicator of claim 18, further comprising means for:
providing the symbol of a first color if the temperament to be indicated is friendly;
providing the symbol of a second color if the temperament to be indicated is sometimes unfriendly;
providing the symbol of a third color if the temperament to be indicated is unfriendly; and
providing the symbol of a fourth color if the temperament to be indicated is unknown or special needs.

20. The pet temperament indicator of claim 18, further comprising means for:
providing the symbol of a first shape if the temperament to be indicated is friendly;
providing the symbol of a second shape if the temperament to be indicated is sometimes unfriendly;
providing the symbol of a third shape if the temperament to be indicated is unfriendly; and
providing the symbol of a fourth shape if the temperament to be indicated is special needs.
